(19) United States
(12) Patent Application Publication
(10) Pub. No.: US 2012/0199095 A1
(43) Pub. Date: Aug. 9, 2012

(54) CAMSHAFT COVER GASKET WITH INTEGRAL PCV BAFFLE

(75) Inventors: Steven G. Bryde, Davisburg, MI (US); Steven C. Taylor, West Bloomfield, MI (US)

(73) Assignee: GM GLOBAL TECHNOLOGY OPERATIONS LLC, Detroit, MI (US)

(21) Appl. No.: 13/042,829

(22) Filed: Mar. 8, 2011

Related U.S. Application Data
(60) Provisional application No. 61/441,056, filed on Feb. 9, 2011.

(51) Int. Cl. F02F 11/00

(52) U.S. Cl. 123/195 C; 277/591; 277/592; 277/594; 277/600

(57) ABSTRACT

A gasket for sealing between a cylinder head and a camshaft cover includes a seal portion that defines a first region and a second region. The first region seals a perimeter of a camshaft chamber, and the second region seals a perimeter of a PCV chamber. A membrane extends across the second region to define a baffle for the PCV chamber that prevents oil from sloshing up from the crankcase into the PCV chamber. The membrane is integrally formed with the seal portion from the same seal material.

### CROSS-REFERENCE TO RELATED APPLICATIONS

This application claims the benefit if U.S. Provisional Patent Application Ser. No. 61/441,056, filed on Feb. 9, 2011, the disclosure of which is hereby incorporated by reference.

### TECHNICAL FIELD

The invention generally relates to a gasket for sealing between a cylinder head and a camshaft cover of an internal combustion engine.

### BACKGROUND

Internal combustion engines include a Positive Crankcase Ventilation (PCV) system for removing blow-by gases from the crankcase of the engine and re-circulating the blow-by gases to a combustion chamber to fully burn any hydrocarbons suspended in the blow-by gases. Burning the hydrocarbons in the blow-by gases reduces hydrocarbon emissions into the atmosphere.

A camshaft cover is attached to a cylinder head and covers an overhead camshaft of the engine. The camshaft cover may define a PCV chamber within an interior thereof. The PCV chamber is in fluid communication with the crankcase to allow removal of the blow-by gases therethrough. Under extreme acceleration and/or handling maneuvers, engine lubricant, i.e., oil, may slosh around within the crankcase, and slosh up into the PCV chamber, whereby the engine lubricant is suspended in the blow-by gases being re-circulated and transmitted therewith to the combustion chamber, resulting in loss of the engine lubricant.

### SUMMARY

A gasket for a camshaft cover of an internal combustion engine is provided. The gasket includes a seal portion. The seal portion defines a first region and a second region. The first region is configured for sealing a perimeter of a camshaft chamber defined between a cylinder head and the camshaft cover. The second region is configured for sealing a perimeter of a Positive Crankcase Ventilation (PCV) chamber defined between the cylinder head and the camshaft cover. The gasket further includes a membrane. The membrane is integrally formed with the seal portion and extends across the second region to define a baffle for the PCV chamber.

A gasket for a camshaft cover of an internal combustion engine is also provided. The gasket includes a seal portion. The seal portion defines a first region and a second region. The first region is configured for sealing a perimeter of a camshaft chamber defined between a cylinder head and the camshaft cover. The second region is configured for sealing a perimeter of a Positive Crankcase Ventilation (PCV) chamber defined between the cylinder head and the camshaft cover. The seal portion includes an outer seal portion defining an outer perimeter, and an inner seal portion bisecting the outer seal portion. The first region is disposed on a first side of the inner seal portion, and is bounded by the outer seal portion. The second region is disposed opposite the first region across the inner seal portion, and is bounded by the outer seal portion. The gasket further includes a membrane. The membrane is integrally formed with and continuously attached to the inner seal portion and the outer seal portion bounding the second region without interruption. The membrane extends across the entire second region to define a baffle for the PCV chamber. The membrane includes a thickness that is approximately equal to 1.0 mm, and defines at least one circular aperture having a diameter that is approximately equal to 0.25 mm.

An internal combustion engine is also provided. The engine includes a block defining a crankcase, and a cylinder head attached to the block. The cylinder head defines at least one fluid passage in fluid communication with the crankcase. A camshaft cover is attached to the cylinder head. The camshaft cover is configured for covering a camshaft chamber defined between the cylinder head and the camshaft cover. The camshaft cover at least partially defines a Positive Crankcase Ventilation (PCV) chamber that is in fluid communication with the at least one fluid passage of the cylinder head to communicate gases from the crankcase to an intake manifold. A gasket is disposed between the camshaft cover and the cylinder head. The gasket is configured for sealing between the camshaft cover and the cylinder head. The gasket includes a seal portion that defines a first region and a second region. The first region is configured for sealing a perimeter of the camshaft chamber defined between the cylinder head and the camshaft cover. The second region is configured for sealing a perimeter of the Positive Crankcase Ventilation (PCV) chamber defined between the cylinder head and the camshaft cover. A membrane is integrally formed with the seal portion. The membrane extends across the second region to define a baffle for the PCV chamber.

Accordingly, the membrane prevents engine lubricant, i.e., oil, from sloshing up through the fluid passage connecting the crankcase and the PCV chamber, and into the PCV chamber, during extreme acceleration maneuvers. As such, the membrane limits the loss of oil that may otherwise escape with the re-circulation of blow-by gases from the crankcase, thereby reducing oil consumption. Any oil that separates from the blow-by gases may drain back down into the crankcase through the perforation(s) in the membrane.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is an exploded schematic diagram of an internal combustion engine.

FIG. 2 is a plan view of a gasket for sealing between a cylinder head and a camshaft cover of the internal combustion engine.

FIG. 3 is an enlarged schematic plan view of a second region of the gasket.

FIG. 4 is a schematic cross sectional view of the second region of the gasket.

### DETAILED DESCRIPTION

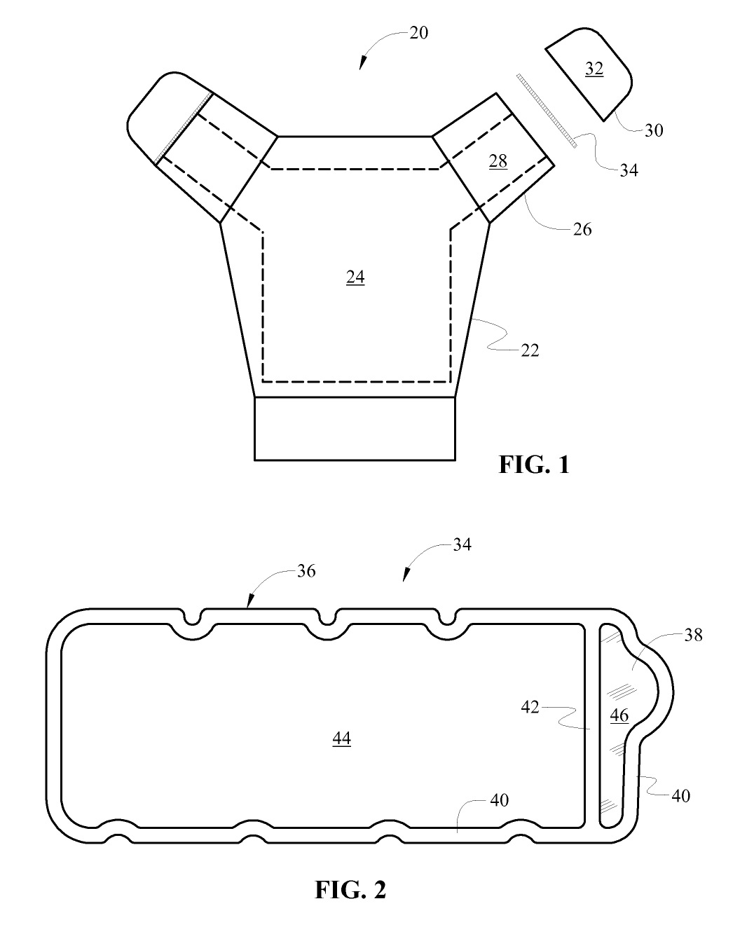

Referring to the Figures, wherein like numerals indicate like parts throughout the several views, an internal combustion engine is shown generally at 20 in FIG. 1. Referring to FIG. 1, the engine 20 includes a block 22 that defines a crankcase 24. The engine 20 may include any type, style, and/or size of engine 20, such as the V-style overhead cam engine 20 schematically depicted in FIG. 1, or an inline engine.

A cylinder head 26 is attached to the block 22. The cylinder head 26 defines at least one fluid passage 28 in fluid communication with the crankcase 24. The fluid passage 28 is part of a Positive Crankcase Ventilation (PCV) system that allows trapped gases within the crankcase 24 to exit the crankcase 24. A camshaft cover 30 is attached to the cylinder head 26. The camshaft cover 30 is configured for covering a camshaft chamber that is defined between the cylinder head 26 and the camshaft cover 30. The camshaft cover 30 at least partially defines a PCV chamber 32, which is in fluid communication with the fluid passage 28 of the cylinder head 26. As such, any gasses trapped within the crankcase 24 may flow through the passage and into the PCV chamber 32 defined by the camshaft cover 30. The trapped gases are then moved to a combustion chamber (not shown) of the engine 20, wherein unburnt hydrocarbons suspended within the trapped gases may be burnt to reduce hydrocarbon emissions.

As used herein, the term camshaft cover 30 is used descriptively relative to a specific type of engine 20, i.e., an overhead cam engine 20. Accordingly, it should be appreciated that the camshaft cover 30 may alternatively be referred to as, a rocker cover suitable for use in a push-rod style engine, and that the scope of the claims should not be limited to an overhead cam engine, but should be interpreted to include any style of engine, including but not limited to a push-rod engine.

A gasket 34 is disposed between the camshaft cover 30 and the cylinder head 26. The gasket 34 is configured for sealing between the camshaft cover 30 and the cylinder head 26. Referring to FIG. 2, the gasket 34 includes a seal portion 36 and a membrane 38. The seal portion 36 includes an outer seal portion 40 and an inner seal portion 42. The outer seal portion 40 defines an outer perimeter, and the inner seal portion 42 bisects the outer seal portion 40 to define a first region 44 and a second region 46. The first region 44 is disposed on a first side of the inner seal portion 42, and is bounded by the inner seal portion 42 and the outer seal portion 40. The second region 46 is disposed opposite the first region 44 across the inner seal portion 42, and bounded by the inner seal portion 42 and the outer seal portion 40. The first region 44 is configured for sealing a perimeter of the camshaft chamber defined between the cylinder head 26 and the camshaft cover 30. The second region 46 is configured for sealing a perimeter of the PCV chamber 32 defined between the cylinder head 26 and the camshaft cover 30.

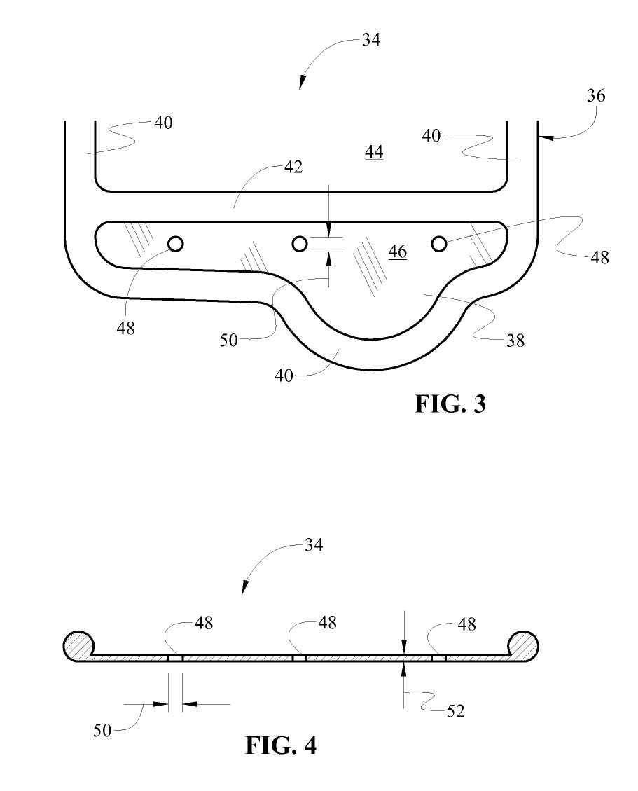

Referring also to FIG. 3, the seal portion 36, including both the outer seal portion 40 and the inner seal portion 42, may include but is not limited to a generally circular cross sectional shape, or some other similar shape designed to compress under pressure between the camshaft cover 30 and the cylinder head 26 to seal therebetween.

The membrane 38 is integrally formed with the seal portion 36 and extends across the second region 46 to define a baffle for the PCV chamber 32. Accordingly, the membrane 38 spans across the entirety of the second region 46. The membrane 38 is continuously attached to the inner seal portion 42 and the outer seal portion 40 that bounds the second region 46 without interruption. Accordingly, there are no breaks in the connection between the membrane 38 and the inner seal portion 42 and/or the outer seal portion 40. When installed, at least a portion of the membrane 38 is suspended across the PCV chamber 32 and the fluid passage 28, i.e., not compressed between the cylinder head 26 and/or the camshaft cover 30, and extends across the fluid passage 28.

Referring to FIGS. 3 and 4, the membrane 38 defines at least one perforation 48. The perforation 48 is aligned with the fluid passage 28 to allow separated engine 20 lubricant, i.e., oil, to drain from the PCV chamber 32 back into the crankcase 24 of the engine 20. As shown, the at least one perforation 48 includes three perforations 48. However, it should be appreciated that the membrane 38 may include any number of perforations 48. The perforations 48 may define any shape and size suitable for allowing separated oil to drain through the perforations 48 and back to the crankcase 24, while small enough to prevent the oil within the crankcase from sloshing up through the fluid passage 28 and into the PCV chamber 32. As shown, the perforations 48 include a circular aperture. Each of the circular apertures includes a diameter 50 that is preferably between the range of 0.15 mm and 0.5 mm. More, preferably, the diameter 50 of the each of the circular apertures is approximately equal to 0.25 mm. However, it should be appreciated that the perforations 48 may include a shape and corresponding size other than shown or described herein.

As shown in FIG. 4, the membrane 38 includes a thickness 52. The thickness 52 is measured perpendicular to a direction of compression of the seal portion 36. Preferably, the thickness 52 is between the range of 0.50 mm and 2.00 mm. More preferably, the thickness 52 of the membrane 38 is approximately equal to 1.0 mm. However, it should be appreciated that the thickness 52 of the membrane 38 may vary from the preferred values described herein.

As described above, the seal portion 36 and the membrane 38 are integrally formed together. The seal portion 36 and the membrane 38 may include and be manufactured from one of a polyacrylate material, a silicone material, a rubber material, a fluoroelastomer material, or some other material suitable for sealing between the camshaft cover 30 and the cylinder head 26 of the engine 20. The gasket 34 may be formed in any suitable manner, including but not limited to injection molding or the like.

While the best modes for carrying out the invention have been described in detail, those familiar with the art to which this invention relates will recognize various alternative designs and embodiments for practicing the invention within the scope of the appended claims.

1. A gasket for a camshaft cover of an internal combustion engine, the gasket comprising:
a seal portion defining a first region and a second region, wherein the first region is configured for sealing a perimeter of a camshaft chamber defined between a cylinder head and the camshaft cover, and wherein the second region is configured for sealing a perimeter of a Positive Crankcase Ventilation (PCV) chamber defined between the cylinder head and the camshaft cover; and
a membrane integrally formed with the seal portion and extending across the second region to define a baffle for the PCV chamber.

2. A gasket as set forth in claim 1 wherein the membrane spans across the entire second region.

3. A gasket as set forth in claim 1 wherein the seal portion includes an outer seal portion defining an outer perimeter, and an inner seal portion bisecting the outer seal portion, wherein the first region is disposed on a first side of the inner seal portion and bounded by the outer seal portion, and wherein the second region is disposed opposite the first region across the inner seal portion and bounded by the outer seal portion.

4. A gasket as set forth in claim 3 wherein the membrane is continuously attached to the inner seal portion and the outer seal portion bounding the second region without interruption.

5. A gasket as set forth in claim 1 wherein the seal portion and the membrane include and are manufactured from one of a polyacrylate material, a silicone material, a rubber material or a fluoroelastomer material.

6. A gasket as set forth in claim 1 wherein the membrane includes a thickness between the range of 0.50 mm and 2.00 mm.

7. A gasket as set forth in claim 6 wherein the thickness of the membrane is approximately equal to 1.0 mm.

8. A gasket as set forth in claim 1 wherein the membrane defines at least one perforation configured to allow separated engine lubricant to drain from the PCV chamber back into a crankcase of the internal combustion engine.

9. A gasket as set forth in claim 8 wherein the at least one perforation includes three perforations.

10. A gasket as set forth in claim 8 wherein the at least one perforation includes a circular aperture.

11. A gasket as set forth in claim 10 wherein the circular aperture includes a diameter between the range of 0.15 mm and 0.5 mm.

12. A gasket as set forth in claim 11 wherein the diameter of the circular aperture is approximately equal to 0.25 mm.

13. A gasket for a camshaft cover of an internal combustion engine, the gasket comprising:
a seal portion defining a first region and a second region, wherein the first region is configured for sealing a perimeter of a camshaft chamber defined between a cylinder head and the camshaft cover, and wherein the second region is configured for sealing a perimeter of a Positive Crankcase Ventilation (PCV) chamber defined between the cylinder head and the camshaft cover;
wherein the seal portion includes an outer seal portion defining an outer perimeter, and an inner seal portion bisecting the outer seal portion, with the first region disposed on a first side of the inner seal portion and bounded by the outer seal portion, and with the second region disposed opposite the first region across the inner seal portion and bounded by the outer seal portion; and
a membrane integrally formed with and continuously attached to the inner seal portion and the outer seal portion bounding the second region without interruption, and extending across the entire second region to define a baffle for the PCV chamber;
wherein the membrane includes a thickness approximately equal to 1.0 mm, and defines at least one circular aperture having a diameter approximately equal to 0.25 mm.

14. An internal combustion engine comprising:
a block defining a crankcase;
a cylinder head attached to the block and defining at least one fluid passage in fluid communication with the crankcase;
a camshaft cover attached to the cylinder head and configured for covering a camshaft chamber defined between the cylinder head and the camshaft cover, wherein the camshaft cover at least partially defines a Positive Crankcase Ventilation (PCV) chamber in fluid communication with the at least one fluid passage of the cylinder head to communicate gases from the crankcase to an intake manifold;
a gasket disposed between the camshaft cover and the cylinder head and configured for sealing therebetween, wherein the gasket includes:
a seal portion defining a first region and a second region, wherein the first region is configured for sealing a perimeter of the camshaft chamber defined between the cylinder head and the camshaft cover, and wherein the second region is configured for sealing a perimeter of the Positive Crankcase Ventilation (PCV) chamber defined between the cylinder head and the camshaft cover; and
a membrane integrally formed with the seal portion and extending across the second region to define a baffle for the PCV chamber.

15. An internal combustion engine as set forth in claim 14 wherein the membrane spans across the entire second region.

16. An internal combustion engine as set forth in claim 14 wherein the seal portion and the membrane include and are manufactured from one of a polyacrylate material, a silicone material, a rubber material or a fluoroelastomer material.

17. A gasket as set forth in claim 14 wherein the membrane includes a thickness approximately equal to 1.0 mm.

18. An internal combustion engine as set forth in claim 14 wherein the membrane defines at least one perforation configured to allow separated engine lubricant to drain from the PCV chamber back into the crankcase.

19. An internal combustion engine as set forth in claim 18 wherein the at least one perforation includes a circular aperture.

20. An internal combustion engine as set forth in claim 19 wherein the circular aperture includes a diameter approximately equal to 0.25 mm.
